(19) United States
(12) Patent Application Publication
(10) Pub. No.: US 2021/0049937 A1
(43) Pub. Date: Feb. 18, 2021

(54) REMOVABLE MEDIA TRACKING MARKINGS

(71) Applicant: Hewlett-Packard Development Company, L.P., Spring, TX (US)

(72) Inventors: Jason M Quintana, Vancouver, WA (US); Jay S Gondek, Vancouver, WA (US)

(21) Appl. No.: 16/981,409

(22) PCT Filed: Apr. 3, 2018
(86) PCT No.: PCT/US2018/025824

§ 371 Date: Sep. 16, 2020

(51) Int. Cl. G09F 3/10; B41J 3/407; B42D 15/00; B41J 21/16; B41J 11/46; B41J 11/00

(52) U.S. Cl. CPC G09F 3/10; B41J 3/4075; B41J 11/0095; B41J 21/16; B41J 11/46; B42D 15/0006

(57) ABSTRACT

An example of a print media can include a substrate, a removable layer coupled to a surface of the substrate, and an object on a surface of the removable layer, the object including tracking markings to permit determination of a velocity of the print media.

### BACKGROUND

Print systems may include a conveying mechanism to transport media to a printer. A velocity of the media along the conveying mechanism may vary.

### BRIEF DESCRIPTION OF THE DRAWINGS

FIG. 1 illustrates an example of print media.

FIG. 2 illustrates another example of print media.

FIG. 3 illustrates an example of an object.

FIG. 4 illustrates another example of an object.

FIG. 5 illustrates yet another example of an object.

FIG. 6 illustrates an example of an imaging device suitable with removable tracking markings.

FIG. 7 illustrates an example of a method employing removable tracking markings.

### DETAILED DESCRIPTION

Print systems, such as printers, copiers, etc., may generate text or images onto print media (e.g., paper, plastic, etc.). Print systems may transfer print substance (e.g., printing fluid and/or toner, etc.) to print media, heat the print media, and/or perform other operations with respect to print media to form text, graphics, and/or other aspects of a print job. As mentioned, print systems may include a conveying mechanism, such as rollers, drums, and belts, to transport print media by imparting movement into the print media. A velocity of the print media along the conveying mechanism may be monitored to help achieve a particular quality of print output. For example, the velocity of the print media may be tracked using mechanical systems such as those employing a rotary encoder. However, such mechanical systems may not be suitable for all types of print systems such as those having a small form factor. Additionally, such mechanical systems may rely on marks such as top of form (TOF) marks on a substrate of a print media that may inherently limit a total amount of printable space on the substrate of the print media.

The disclosure is directed to removable tracking markings as a mechanism to permit velocity determinations of print media, such as those without complex and/or costly mechanisms like rotary encoders and/or without marks on a substrate of a print media. For example, a print media can include a substrate, a removable layer coupled to a surface of the substrate, and an object on a surface of the removable layer, as detailed herein. Removable tracking markings can permit determination of a velocity of a print media when coupled to the print media, and notably can be decoupled from a substrate of the print media to provide a greater total amount of printable space on the print media and/or provide a resultant print media that is tracking marking free, as detailed herein.

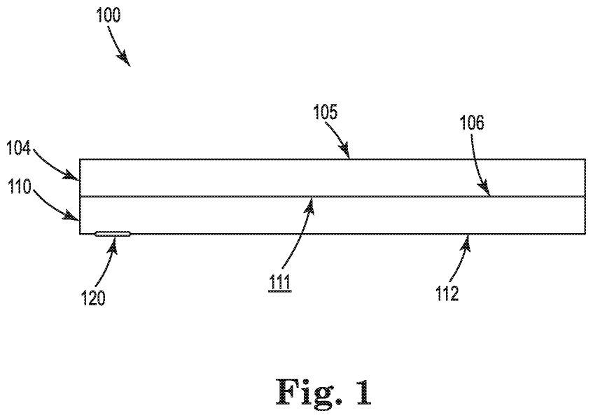

FIG. 1 illustrates an example of print media 100. As illustrated in FIG. 1, the print media 100 can include a substrate 104, a removable layer 110, and an object 120.

The substrate 104 refers to a material that is to couple to the removable layer 110 and is to receive a printing agent (e.g., printing fluid, various plastic/metal or other types of particulates, etc.), receive heat, etc. to form content (text, images, etc.) on the substrate. The substrate 104 can be formed of paper, a polymeric film, plastic, metal and/or combinations thereof, among other possible materials. The substrate 104 can be opaque, transparent, translucent, reflective or retroreflective. While illustrated as having a rectangular shape, the size and/or shape of the substrate 104 and/or the print media can be varied.

The substrate 104 includes a first surface 105 and a second surface 106. As illustrated in FIG. 1, the second surface 106 can be opposite from the first surface 105. In various examples, the first surface 105 is to receive a printing agent, receive heat, etc. to form content (text, images, etc.) on the first surface 105 of the substrate 104. For instance, the first surface 105 can be formed of a material such paper or other suitable material to receive a printing agent such as those described herein.

As illustrated in FIG. 1, in various examples the removable layer 110 can be coupled to the second surface 106. The removable layer 110 refers to a layer of material that is to couple to and subsequently be decoupled from the substrate 104. The removable layer 110 can be formed of paper, a polymeric film, plastic, metal and/or combinations thereof, among other possible materials. The removable layer 110 can include a first surface 111 and a second surface 112.

As illustrated in FIG. 1, the first surface 111 of the removable layer 110 can be coupled to the second surface 106 of the substrate 104, among other possibilities. In some examples, the first surface 111 of the removable layer 110 can be directly coupled (without intervening elements) to the second surface 106 of the substrate 104. For instance, the substrate 104 and the removable layer 110 can be made of a material that results in a static electrical charge coupling the substrate 104 directly to the removable layer 110 to provide a comparatively thinner profile than approaches employing intervening elements such as an adhesive. Examples of suitable materials to impart a static electrical charge include various plastics such as polyester and/or styrene among others suitable materials. However, while the substrate 104 can be directly coupled to the removable layer 110 the disclosure is not so limited. For instance, the removable layer 110 can be coupled to the substrate 104 via an adhesive, as detailed herein, and/or other intervening element such as a release liner.

As illustrated in FIG. 1, the object 120 can be located on a surface (e.g., the second surface 112) of the removable layer 110. As used herein, an object refers to a group of tracking markings that permit determination of a velocity of a print media, such as those that may be used in conjunction with a sensor, as detailed herein. As used herein, tracking markings refer to visible and/or invisible tracking markings of any total number, shape, size, color, etc. that are suitable to be sensed and used to determine a media velocity. As used herein, decoupling the object from the substrate can include decoupling a removable layer (e.g., including an object on a surface of the removable layer) from the substrate.

While represented in FIG. 1 as being a visible object, the object 120 can be visible or invisible due to having visible or invisible tracking markings, respectively. As used herein, an invisible object refers to a group of tracking markings formed of printing agent that is invisible to an unaided human eye but that is detectable by a sensor capable of detecting light in ultraviolet, infrared, or other portions of the electromagnetic spectrum. Examples of invisible tracking markings include ultraviolet (UV) markings, infrared (IR) markings, magnetic markings, and/or heat markings, among other invisible tracking markings. For instance, an invisible object can be detected by a sensor, as described herein, when the invisible object is illuminated by ultraviolet or infrared light, among other possibilities.

In other examples, the object 120 can be a visible tracking mark. As used herein, a visible object can be formed of black or other colored printing agent and be visible to an unaided human eye. A visible object can be shaped, colored, sized, and/or oriented in a number of possible manners. For example, a visible object can be shaped, colored, sized, and/or oriented to avoid interfering with or reducing an area of the print media available to receive a printing agent. A visible object can also provide a particular aesthetic due in part to the object 120 being disposed on the removable layer (e.g., as opposed to being disposed on a substrate). A visible object can also convey information (e.g., represent a trademark, logo, and/or other information) to an end user or other individual due in part to the object having non-uniform tracking markings.

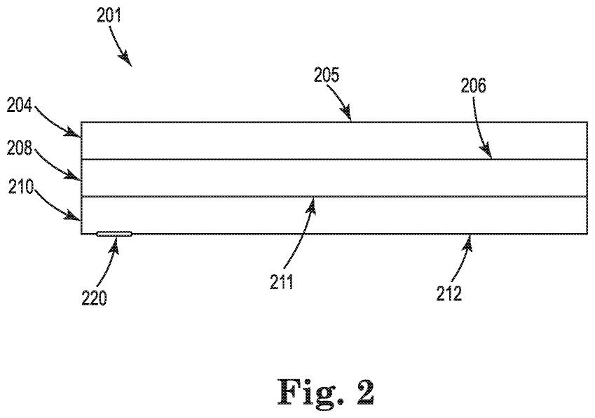

FIG. 2 illustrates another example of a print media 201. Similar to FIG. 1, the print media 201 can include a substrate 204 having a first surface 205 and a second surface 206 and a removable layer 201 having a first surface 211 and a second surface 212. As illustrated in FIG. 2, in some examples a removable layer 210 can be coupled via an adhesive 208 and/or other intervening element such as a release liner to the substrate 204.

The adhesive 208 can be a pressure-sensitive adhesive. As used herein, a pressure-sensitive adhesive refers to an adhesive that is tacky at ambient temperature to permit adhering to substrates, such as those describe herein, such as in response to application of pressure (e.g., hand pressure). The pressure-sensitive adhesive can in various examples be employed without an activator such as water, solvent, and/or heat. Suitable pressure-sensitive adhesives include those selected from a group including alkylacrylate polymers and copolymers; copolymers of alkylacrylates with acrylic acid; terpolymers of alkylacrylates, acrylic acid, and vinyl-lactates; alkyl vinyl ether polymers and copolymers; polyisoalkylenes; polyalkyldienes; alkyldiene-styrene copolymers; styrene-isoprene-styrene block copolymers; polydialkylsiloxanes; polyalkylphenylsiloxanes; natural rubbers; synthetic rubbers; chlorinated rubbers; latex crepe; rosin; cumarone resins; alkyd polymers; and polyacrylate esters and mixtures thereof. Further examples include polyisobutylenes, polybutadienes, or butadiene-styrene copolymers, and mixtures thereof (such polymers and copolymers have no reactive moieties, i.e., are not oxidized in the presence of air); silicone-based compounds such as polydimethylsiloxane, and polymethylphenylsiloxane combined with other resins and/or oils, among other suitable pressure-sensitive adhesives.

As illustrated in FIG. 2, the print media 201 can include an individual tracking mark. However, in some examples the print media 201 can include a plurality of objects, as detailed herein. While FIG. 2 illustrates the object 220 as extending across or being located on a portion, but not all of, the second surface 212 of the removable layer 210, the disclosure is not so limited. Rather, an object can extend across some, or all of, an area of a surface of the removable layer 210.

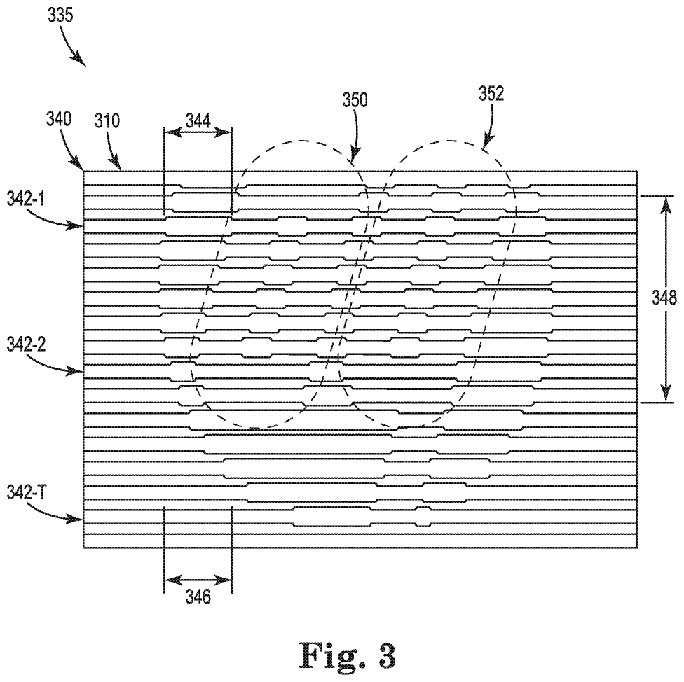

FIG. 3 illustrates an example of an object 340. The object 340 can extend over a portion of a surface of a removable layer 310 of a print media 335. For instance, the tracking markings of the object 340 can extend across an entire area of a surface of the removable layer 310, as illustrated in FIG. 3. However, in some examples, tracking markings of a tracking marking can extend across a portion of, but not all of, a width and/or length of a surface of the removable layer 310.

As illustrated in FIG. 3, the object 340 can include a plurality of tracking markings 342-1, 342-2, . . . , 342-T. In various examples, the tracking markings 342-1, . . . , 342-T can be formed of a plurality of continuous lines, as illustrated in FIG. 3. That is, each individual tracking marking can be formed of a respective continuous line. However, the tracking markings can, in some examples, be formed of discontinuous lines, dots, or other characters/elements.

As illustrated in FIG. 3, the tracking markings 342-1, . . . , 342-T can be non-uniform. That is, a color, shape, thickness, degree of transparency, and/or sharpness, among other possible elements can vary between the tracking marking. Notably, having an invisible non-uniform tracking markings and/or visible non-uniform tracking markings can permit conveying additional information via an object 340, for instance, to convey information (e.g., represent a trademark, logo, and/or other information) to an end user or other individual. As such, in some examples a first tracking marking can have a different thickness, length, shape, physical orientation (e.g., relative the substrate), color, pattern, or combinations thereof than the second tracking marking.

For example, a first individual tracking marking 342-1 can have a different thickness than a thickness of a second tracking marking 342-2. For instance, is illustrated in FIG. 3, the first individual tracking marking 342-1 can have a given thickness 344 along a portion of the first individual tracking marking 342-1 while the second tracking marking 342-2 can have a different thickness 346 along a portion of the second tracking marking 342-2 than the given thickness 344 of the first tracking marking 342-1 along a common axis 348. By selective varying a thickness (and/or other aspect) of tracking markings an image/characters can be formed in the object 340. For instance, as illustrated in FIG. 3 the object 340 includes characters (e.g., characters 350 and 352) that are formed by varying respective thicknesses along portions of the tracking marking 342-1, . . . , 342-T.

While FIG. 3, illustrates a given number of a particular type of tracking markings 342-1, . . . , 342-T the disclosure is not so limited. Rather, an orientation (e.g., relative the other tracking markings and/or relative a removable layer), a total number, a color, a shape, etc. of the tracking markings 342-1, . . . , 342-T can be varied.

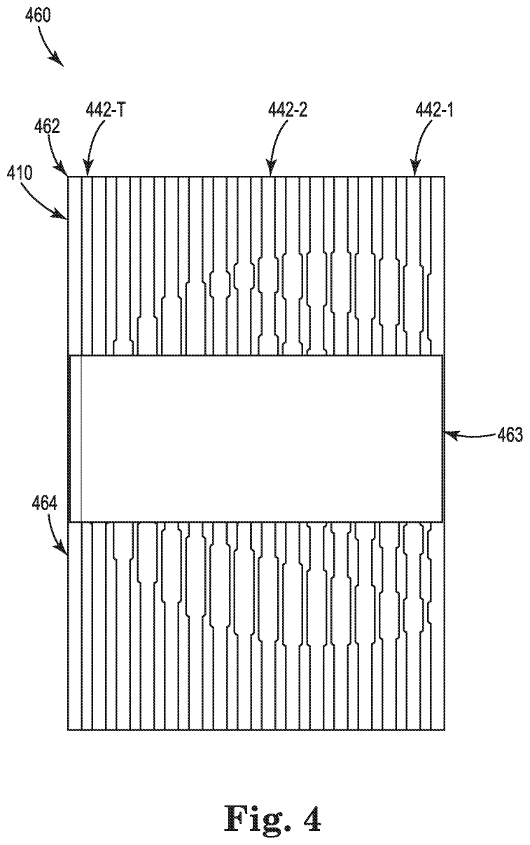

For instance, FIG. 4 illustrates another example of an object. As illustrated in FIG. 4, a print media 460 can include plurality of objects such as a first object 462 and a second object 464. Each object can include a plurality of tracking markings such as tracking markings 442-1, 442-2, 442-T of the first object 462. The plurality of objects can be uniform or non-uniform with respect to each other. For instance, as illustrated in FIG. 4, the first visible object 462 can be non-uniform with respect to the second visible object 464, among other possibilities.

The objects 462, 464 can extend over a portion of a surface such as a second surface of a removable layer 410. That is, as illustrated in FIG. 4, the print media can have a blank area or other area 463 that is free of objects and/or tracking markings. The blank area or other area 463 can be located between and/or around objects. While illustrated as two objects, a print media can include fewer or a greater total number of objects. As mentioned, the object can be a visible object on a surface of the removable layer. For instance, the print media 460 can include a plurality of visible objects disposed on a surface of the removable layer such as the first object 462 and the second object 464. The print media 460 can include other components such as a substrate and/or an adhesive (not shown for ease of illustration), among other components.

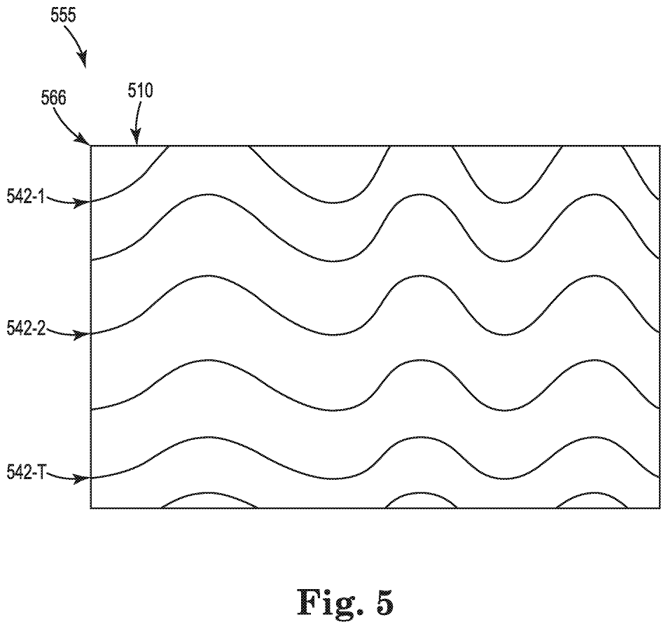

FIG. 5 illustrates yet another example of an object. As illustrated in FIG. 5, an object can be a non-linear object 566 located on a surface of a removable layer 510 of a print media 555. As used herein, a non-linear object refers to an object that includes non-linear lines and/or elements. In some examples, a non-linear object 566 can include non-linear tracking markings such as tracking markings 542-1, 542-2, . . . , 542-T illustrated in FIG. 5, among other possible types of non-linear lines and/or elements. The print media 555 can include other components such as a substrate and/or an adhesive (not shown for ease of illustration), among other components.

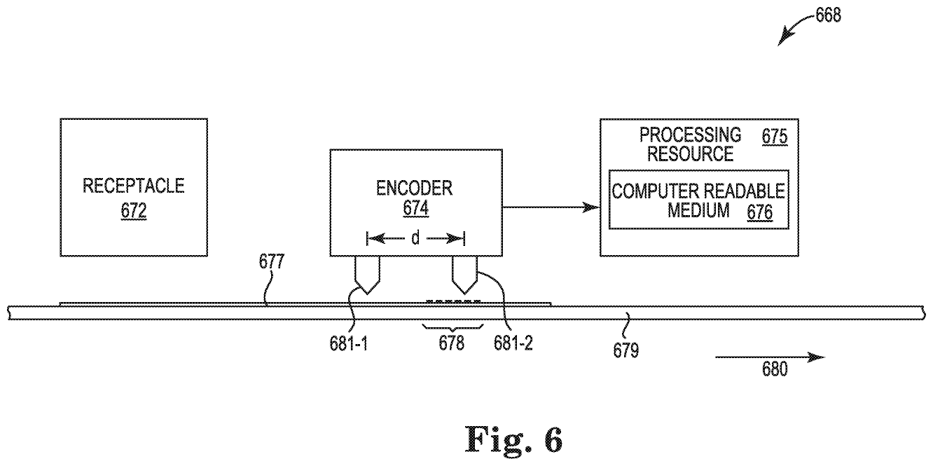

FIG. 6 illustrates an example of an imaging device 668 suitable with removable tracking markings. As used herein an imaging device refers to a device suitable to generate text and/or images, etc, onto print media. The imaging device 668 is shown to include a receptacle 672, an encoder 674, a processing resource 675 and a computer readable medium 676.

The receptacle 672 defines a volume to receive print media 677 including an object, as described herein. The print media 677 can be delivered by a media belt 679 and/or other suitable device to convey the print media (in a direction of travel 680 of media) from the receptacle. The encoder 674 is positioned downstream from the receptacle 672 and is to sense or otherwise detect an object 678 as the media travels along a direction of travel 680 on the media belt 679. Object 678 can be analogous to object 120, 220, 340, 462, 464, and/or 566, as described herein, among other possibilities.

In some examples, the encoder 674 is a media encoder unit (MEU) included in a plurality of MEUs. A MEU refers to device that can produce timing signals to promote printing of a print job. For instance, the encoder 674 can be non-rotary encoder such as a reflective/optical encoder, among other possibilities. As illustrated in FIG. 6, the encoder 674 can include two distinct sensors, 681-1 and 681-2, respectively, which are spaced from each other a specified distance d, among other possible combinations and/or total numbers of sensors that can be included in an encoder. As used herein, sensors refer to optical sensors such as those having a capability to detect a visible and/or invisible object. Because the distance d can be identified or known, the velocity of the print media 677 can be determined by identifying the time at which a given tracking marking is sensed by the first sensor 681-1, and then later sensed by the second sensor 681-2. Stated differently, a velocity of the print media along the print path can be determined based on the sensed location of the tracking markings of the visible object. Specifically, the velocity (v) of the print media 677 can be determined from the relation:

v=d/Δt (Equation 1)

where, Δt=(t681-1−t681-2)

The velocity determination is made by the processing resource 675. The processing resource 675 receives the signals, from the first sensor and the second sensor, 681-1 and 681-2, respectively, and calculates the velocity based on those signals. For example, an object sequentially arrives at the first sensor 681-1 and then at the second sensor 681-2. As each object passes under the first sensor 681-1, the first sensor detects tracking markings of the object and sends a pulse (e.g., a signal) to the processing resource 675. Therefore, if, in an example, there are six tracking markings in a given group of tracking markings, a pulse train of six pulses is sent to the processing resource 675. That is, such a pulse train can include a plurality of individual pulses that pertain to individual objects and/or individual tracking markings of a given object. Each pulse can have a peak that corresponds to the center of a objects and/or individual tracking markings of a given object. Pulses can be sinusoidal (as opposed to square), among other possibilities, given the nature with which the first sensor 681-1 senses the tracking marking as it travels past. For instance, referring to a first pulse in a pulse train, the first sensor 681-1 can detect a leading edge of an object at time t1, the center of the object at time t2, and the trailing edge of the object at time t3. In various examples, different pulse shapes can be produced depending upon the type of sensor used.

Because the second sensor 681-2 is positioned a short distance (e.g., the distance d in FIG. 6) downstream from the first sensor 681-1, the second sensor 681-2 can detect tracking markings after the first sensor 681-1. Therefore, the second sensor 681-2 generates its own pulse train that includes pulses that are shifted in time relative to the pulses of the first sensor 681-1. The difference between the time at which the first sensor 681-1 detects an object and/or individual tracking markings of the object and the time the second sensor 681-2 detects the object and/or the individual tracking markings of the object is the time difference Δt that is used in Equation 1 to calculate the velocity of the media 677. For example, such a difference can be equal to the time between the first peak of a first pulse in a first pulse train and a first peak of a first pulse in a second pulse train.

Although a reasonably accurate measurement of the velocity of the media 677 could be obtained from an individual object and/or individual tracking marking (e.g., an individual pulse from each sensor), comparatively increased accuracy of results can be obtained when multiple pulses from the first sensor 681-1 are correlated with multiple pulses from the second sensor 681-2, In such a process, the shapes of the pulses in the first pulse train are matched to the shapes of the pulses in the second pulse train, for instance, so that respective peaks of the matched pulses can be correlated with greater accuracy and, therefore, the time difference can be likewise determined with greater accuracy. Although any number of pulses can be correlated in this manner, the greater the number of pulses that are correlated, the greater the accuracy with which the time between arrival of the media 677 at each sensor 681-1, 681-2 can be calculated.

Once a velocity of the media 677 has been determined, that velocity can be used as input into an encoder signal emulator (not shown) included in the imaging device 668, which generates a signal that emulates that of a mechanical encoder such as a rotary encoder. The emulator generates a further pulse train that simulates the pulses that would be sent by a mechanical encoder for each object and/or tracking marking of an encoder disk that is sensed.

The processing resource 675 can output emulated encoder signals that can be sent to vary a printing attribute (e.g., dots per inch, etc.) of the imaging device 668 based on the determined velocity of the print media. The processing resource 675, as used herein, can include a processor capable of executing instructions stored by the computer readable medium 676. Processing resource 675 can be integrated in an individual device (e.g., an imaging device) or distributed across multiple devices (e.g., printing systems, and/or servers). The instructions (e.g., computer-readable instructions (CRI)) can include instructions stored on the computer readable medium 676 and executable by the processing resource 675 to implement a particular function (e.g., determine a velocity of the print media along the print path based on the sensed location of the visible tracking mark, etc.).

The computer readable medium 676 can be in communication with a processing resource 675. A computer readable medium 676, as used herein, can include a memory component capable of storing instructions that can be executed by processing resource 675. Such computer readable medium 676 can be a non-transitory CRM. Computer readable medium 676 can be integrated in an individual device or distributed across multiple devices. Further, computer readable medium 676 can be fully or partially integrated in the same device as processing resource 675 or it can be separate but accessible to that device and processing resource 675.

The computer readable medium 676 can be in communication with the processing resource 675 via a communication link (not shown). The communication link can be local or remote to a computing device associated with the processing resource 675. Examples of a local communication link can include an electronic bus internal to a computing device where the computer readable medium 676 can be a volatile, non-volatile, fixed, and/or removable storage medium in communication with the processing resource 675 via the electronic bus.

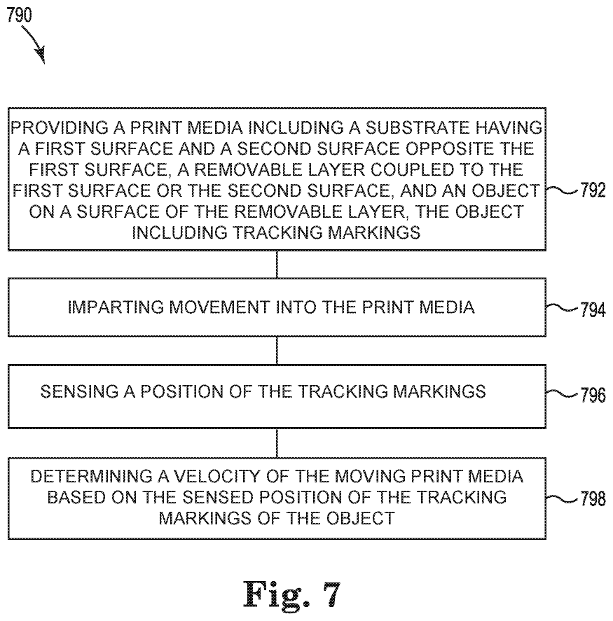

FIG. 7 illustrates an example of a method 790 removable tracking markings. The method 790 can include providing a print media. Providing refers to the procurement and/or manufacture of an article such as print media. For instance, the method 790 can include providing a print media including a substrate having a first surface and a second surface opposite the first surface, a removable layer coupled to the first surface or the second surface; and an object on a surface of the removable layer, at 792. As described herein, the object can include tracking markings.

At 794 the method 790 can include imparting movement into the print media, as described herein. At 796 the method 790 can include sensing a position of the tracking mark, for instance, by a sensor such as those described herein. At 798 the method 790 can include determining a velocity of the moving print media based on the sensed position of the tracking markings of the object, as described herein.

In some examples, the method 790 can include decoupling the removable layer from a surface to expose the pressure-sensitive adhesive and adhering the tracking marking-free print media via the exposed pressure-sensitive adhesive to an article. In this manner, the substrate can be employed as a label or other item that can be adhered via the pressure-sensitive adhesive to an article.

In the foregoing detailed description of the disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the disclosure.

The figures herein follow a numbering convention in which the first digit corresponds to the drawing figure number and the remaining digits identify an element or component in the drawing. For example, reference numeral 104 can refer to element “04” in FIG. 1 and an analogous element can be identified by reference numeral 204 in FIG. 2. Elements shown in the various figures herein can be added, exchanged, and/or eliminated so as to provide additional examples of the disclosure. In addition, the proportion and the relative scale of the elements provided in the figures are intended to illustrate the examples of the disclosure and should not be taken in a limiting sense.

What is claimed:

1. A print media including:
a substrate;
a removable layer coupled to a surface of the substrate; and
an object on a surface of the removable layer, the object including tracking markings to permit determination of a velocity of the print media.

2. The print media of claim 1, wherein the removable layer is coupled via an adhesive to the surface of the substrate.

3. The print media of claim 1, wherein the object comprises a visible object.

4. The print media of claim 3, wherein the tracking markings including a first tracking marking and a second tracking marking, and wherein the first tracking marking is non-uniform with respect to the second tracking marking.

5. The print media of claim 4, wherein the first tracking marking has a different thickness, length, shape, physical orientation, color, pattern, or combinations thereof than the second tracking marking.

6. The print media of claim 3, wherein the visible object included in a plurality of visible objects on the removable layer.

7. The print media of claim 6, wherein the visible object of the plurality of visible objects is non-uniform with respect to a second visible object of the plurality of visible objects.

8. The print media of claim 1, wherein the object includes a non-linear object.

9. The print media of claim 8, wherein the non-linear object includes a sinusoidal tracking marking.

10. The print media of claim 1, wherein the substrate further comprises:
a first surface; and
a second surface that is opposite from the first surface, and wherein the removable layer is removably coupled to the second surface of the substrate.

11. An imaging device comprising:
a sensor;
a receptacle to receive print media and permit the print media to travel along a print path of the imaging device, the print media comprising:
a substrate including a first surface and a second surface;
an adhesive disposed on the second surface of the substrate;
a removable layer coupled via the adhesive to the second surface of the substrate; and
a visible object on a surface of the removable layer, the object including tracking markings to permit determination of a velocity of the print media;
a processing resource; and
a computer readable medium storing non-transitory computer-readable instructions executable by the processing resource to:
cause the sensor to sense a location of the visible object along the print path; and
determine a velocity of the print media along the print path based on the sensed location of the tracking markings of the visible object.

12. The imaging device of claim 11, further comprising instructions to vary a printing attribute of the imaging device based on the determined velocity of the print media.

13. The imaging device of claim 12, wherein the sensor includes a first sensor and a second sensor, wherein the visible object is included in a plurality of visible objects, and wherein the instructions further comprise instructions to determine the velocity of the print media based on a time between the first sensor sensing tracking markings of the plurality of visible objects and the second sensor sensing the tracking markings of the plurality of visible objects.

14. A method comprising:
providing a print media including:
a substrate having a first surface and a second surface opposite the first surface;
a removable layer coupled to the first surface or the second surface; and
an object on a surface of the removable layer, the object including tracking markings;
imparting movement into the print media;
sensing a position of the tracking markings; and
determining a velocity of the moving print media based on the sensed position of the tracking markings of the object.

15. The method of claim 14, wherein the print media further comprises a pressure-sensitive adhesive disposed between the second surface of the substrate and the removable layer, decoupling the removable layer from the second surface to expose the pressure-sensitive adhesive, and adhering the tracking marking-free print media via the exposed pressure-sensitive adhesive to an article.
